(19) United States
(12) Patent Application Publication
(10) Pub. No.: US 2012/0081410 A1
(43) Pub. Date: Apr. 5, 2012

(54) METHOD OF DRIVING DISPLAY PANEL AND DISPLAY APPARATUS FOR PERFORMING THE SAME

(76) Inventors: Dong-Hyun Yeo, Gyeonggi-do (KR); Byung-Kil Jeon, Chungcheongnam-do (KR); Byoung-Seok Yoo, Incheon (KR); Yong-Bum Kim, Gyeonggi-do (KR); Jae-Gwan Jeon, Incheon (KR)

(21) Appl. No.: 13/099,629

(22) Filed: May 3, 2011

(30) Foreign Application Priority Data
Sep. 30, 2010 (KR) 10-2010-0095240

(51) Int. Cl. G09G 5/10; G06F 3/038

(52) U.S. Cl. 345/690; 345/212

(57) ABSTRACT

Rather than using complex zigzag patterns or the like for counter-compensating for the different lengths of fanout lines used to transmit data line drive voltages from more concentrated source points of the drive voltages to more spread apart data lines of a given display panel, digital data signals that represent the to be output data line drive voltages are automatically adjusted so that the data line drive voltages output from the concentrated source points are pre-adjusted to counter voltage drop difference effects that will be applied to those pre-adjusted data line drive voltages by the difference of resistances among the fanout lines of different lengths.

### PRIORITY STATEMENT

This application claims priority under 35 U.S.C. §119 to Korean Patent Application No. 2010-95240, filed on Sep. 30, 2010 in the Korean Intellectual Property Office (KIPO), the contents of which application are herein incorporated by reference in their entirety.

### BACKGROUND

1. Field of Disclosure

The present disclosure of invention relates to methods of driving a display panel and to a display apparatus structured for performing the methods. More particularly, the present disclosure relates to a method of driving a display panel where the method is capable of compensating for a difference of respective resistances of fanout lines having respective different fanout angles, where each of the fanout lines connects terminals of a corresponding driving chip to corresponding parallel data lines of a display apparatus.

2. Description of Related Technology

Generally, a liquid crystal display (LCD) apparatus includes an LCD panel structured for displaying an image and panel drive circuitry structured for driving the LCD panel. The LCD panel typically includes an integrated display substrate on which there are integrally provided: a switching element, a gate line disposed for transmitting a gate voltage signal to the switching element, and a data line disposed for transmitting a data voltage signal to the switching element. More specifically, plural data lines are provided substantially parallel to one another and spaced apart at a regular pitch whose value is dependent on the size and orientation of rectangle-like pixel units (e.g., pixel units can have a 3 to 1 aspect ratio in the case of RGB pixel units that are stacked adjacent to one another).

The panel driver typically includes one or more monolithically integrated circuits (IC's), referred to herein as driving chips where the IC's have respective output terminals disposed at an IC-specific spacing apart from one another so as to apply corresponding driving signals to corresponding ones of the substantially parallel data lines of the LCD panel. Quite often, the output terminals of the one or more driving chips are concentrated in a small area and they are bonded to similarly concentrated bonding pads (e.g., ball grid pads) provided in an area of the LCD panel where the corresponding driving chip is mounted. The spacings between the concentrated bonding pads are typically much smaller than the pitch of the data lines to which they are to connect and thus, a fanout part is included coupling the concentrated bonding pads to the more widely spread apart data lines.

More specifically, in the fanout part there are provided a plurality of differently angled fanout lines each of which connects a respective output terminal of the driving chip to a corresponding one of the data lines in a fanout manner where a gap between adjacent fanout lines gradually increases when moving from the output terminal ends of the fanout lines to the data line connecting ends of the fanout lines. In addition, respective lengths of the different fanout lines vary according to which output terminals of the driving chip and which data lines of the panel are interconnected by the respective fanout lines.

Since the lengths of the fanout lines vary, fanout resistances of the fanout lines may vary if the fanout lines are structured with substantially same cross sectional areas and same conductive materials. In such a case, when data voltages that are intended to represent identical image gray scales are outputted from the driving chip to different ones of the fanout lines, the ultimate data line voltages that appear at the pixel units can vary due to the differences of the respective fanout resistances even though identical voltages were intended for identical image gray scale values. Accordingly, light transmittances may vary as between pixel units that were intended to display identical image gray scale outputs. Thus, a display quality of the display apparatus may be deteriorated.

To compensate for the difference of lengths of the fanout lines, in one conventional method, the fanout lines have different zigzag patterns. For example, a first fanout line connected to a first data line may have a longer distance to go from its source point (and thus greater initial resistance) and may therefore have a short zigzag pattern or no zigzag pattern at all whereas, in contrast, a second fanout line connected to a second data line that has a shorter distance to go from its source point (and thus lower initial resistance) may have a comparatively longer zigzag pattern which provides a compensating increase in resistance.

Recently, in order to decrease the number of the driving chips (each of relatively high cost) provided on a display panel, a multi-channel driving chip has been developed with a greater number of output terminals. The multi-channel driving chip is connected to more data lines as compared to the conventional driving chip so that the fanout lines of the multi-channel IC need to be more densely formed. In addition, a size of a black matrix covering the fanout area needs to be maintained in a predetermined size range to decrease the manufacturing cost so that an area on which the fanout lines are mounted may be limited. In accordance with the above, when the density of the fanout lines needs to increase, zigzagging may no longer be possible because the fanout lines will overlap with each other in a restricted space, and accordingly a fanout design based on zigzagging may be impossible or a process margin may be dangerously decreased thus leading to lower yields or a greater rate of in-filed failure. Such is not acceptable and a novel and different solution is needed.

It is to be understood that this background of the related technology section is intended to provide useful background for understanding the here disclosed technology and as such, the technology background section may include ideas, concepts or recognitions that were not part of what was known or appreciated by those skilled in the pertinent art prior to corresponding invention dates of subject matter disclosed herein.

### SUMMARY

The present disclosure of invention provides a method of driving a display panel so as to electronically compensate for a difference of resistances of fanout lines, each of which connects a specified driving chip to corresponding data lines of prespecified pitch where the method can be carried out without enlarging a fanout area due to excessive zigzagging of fanout lines.

In an example method of driving a display panel according to the present disclosure, digital image data that is to be directed to a predetermined fanout line has compensation added to it for compensating for a difference of resistances among different fanout lines (due for example to differences of lengths of the fanout lines). After the so-compensated digital image data is generated, a corresponding analog data voltages corresponding to the compensated data is generated and applied through the predetermined fanout line for respective routing to its corresponding one of spaced apart plural data lines.

In an example embodiment, a grayscale representing digital data signal corresponding to a grayscale value is automatically altered by an automatically selected fanout compensating value to thus generate the compensated data. The fanout compensating value is selected according to the fanout line through which a corresponding analog voltage will be transmitted to thus drive a corresponding data line at a distal end of the fanout line.

Other aspects of the present disclosure will become apparent from the below detailed description.

### BRIEF DESCRIPTION OF THE DRAWINGS

The above and other features and advantages of the present disclosure of invention will become more apparent by describing in detailed example embodiments thereof with reference to the accompanying drawings, in which:

FIG. 1 is a block diagram schematically illustrating a display apparatus according to an example embodiment;

FIG. 2 is a plan view conceptually illustrating a display panel layout and a data driver of FIG. 1;

FIG. 3 is an enlarged layout view of a portion A of FIG. 2;

FIG. 4A is a graph illustrating a change of fanout resistance as a function of the fanout line of FIG. 2 through which a data line driving voltage will be transmitted;

FIG. 4B is a graph illustrating a developed pixel drive voltage according to the selected fanout line of FIG. 2;

FIG. 4C is a graph illustrating how light transmittance of a corresponding pixel may be varied according to the selected fanout line of FIG. 2;

FIG. 5 is a block diagram illustrating a timing controller of FIG. 1;

FIG. 6 is a graph illustrating a compensation effect on the light transmittance of respective pixels that is achieved by using the compensated data signal;

FIG. 7 is a flowchart illustrating a method of driving the display panel of FIG. 1;

FIG. 8 is a flowchart illustrating generating the compensated data signal of FIG. 7;

FIG. 9 is a graph illustrating a compensation of a light transmittance of a pixel using compensated data of a display apparatus according to another example embodiment; and

FIG. 10 is a graph illustrating a compensation of a light transmittance of a pixel using compensated data of a display apparatus according to still another example embodiment.

### DETAILED DESCRIPTION

Hereinafter, the present disclosure of invention will be explained in detail with reference to the accompanying drawings.

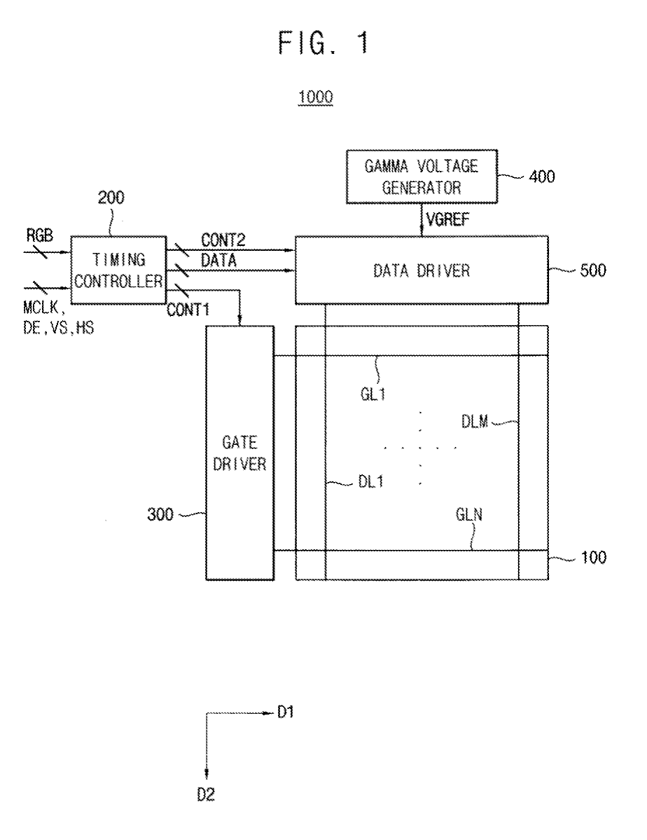

FIG. 1 is a block diagram illustrating a display apparatus 1000 according to a first example embodiment in accordance with the disclosure.

Referring to FIG. 1, the display apparatus 1000 includes a display panel 100, a timing controller 200, a gate driver 300, a gamma voltage generator 400 and a data driver 500.

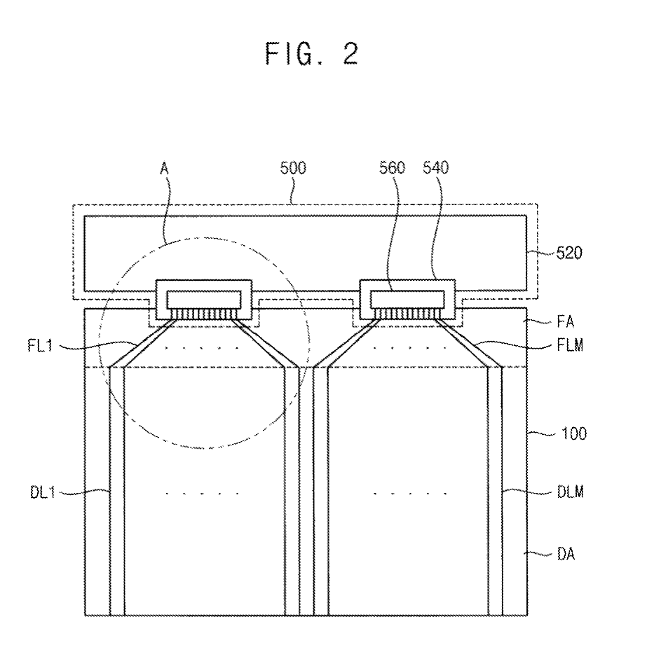

The display panel 100 includes a plurality of gate lines GL1 to GLN, a plurality of data lines DL1 to DLM and a plurality of pixel units (not shown) each connected to a respective one or more of the gate lines GL1 to GLN and a respective one or more of the data lines DL1 to DLM. The gate lines GL1 to GLN extend in parallel along a first direction D1 while being spaced apart from one another according to a gate lines pitch dimension. The data lines DL1 to DLM extend in parallel along a second direction D2 crossing the first direction D1 while being spaced apart from one another according to a data lines pitch dimension. Herein, N and M are natural numbers greater than one. Each pixel unit (not shown) includes at least one switching element (not shown), at least one liquid crystal capacitor (not shown) and a storage capacitor (not shown). The liquid crystal capacitor includes a pixel-electrode (not shown) of predetermined length and width dimensions, which dimensions dictate the gate lines and data lines pitch dimensions. Although in the schematic representation of FIG. 1, the gate lines and data lines are shown to extend in parallel from edges of the panel 100 and to signal sourcing terminals of the respective gate lines driver circuitry 300 and of the data lines driver circuitry 500, in terms of physical layout this generally not the case as will be explained shortly in conjunction with FIG. 2.

Still referring to FIG. 1, the timing controller 200 receives input image data signal and a control signal. The input image data signal may include red image data R, green image data G and blue image data B. The control signal may include a master clock signal MCLK, a data enable signal DE, a vertical synchronizing signal VS and a horizontal synchronizing signal HS.

The timing controller 200 generates a first control signal CONT1, a second control signal CONT2 and compensated data signal, DATA based on the input image data signal and on the control signal and on a provided mapping that indicates what kind of fanout line among different fanout lines, corresponding portions of the compensated data signal, DATA will be each logically associated to. The timing controller 200 generates the first control signal CONT1 for controlling driving timing of the gate driver 300 based on the control signal to output the first control signal CONT1 to the gate driver 300. The timing controller 200 generates the second control signal CONT2 for controlling driving timing of the data driver 500 based on the control signal to output the second control signal CONT2 to the data driver 500. In addition and as mentioned, the timing controller 200 generates the compensated data signal, DATA where generation of this signal (DATA) includes compensating for a difference of respective resistances of fanout lines having respective different fanout angles or paths, where each of the fanout lines connects terminals of a corresponding driving chip (e.g., 500) to corresponding ends of the parallel data lines DL1-DLm of the display apparatus. More specifically, corresponding portions of the compensated data signal, DATA are automatically pre-adjusted for compensating for differences of resistances among respective fanout lines FL1 to FLM, where the differences of resistances may be due to differences of lengths of the fanout lines FL1 to FLM. A more detailed explanation of operation of one embodiment of the timing controller 200 will be provided in detail below in conjunction with referring to FIG. 5.

The first control signal CONT1 output by circuit 200 may include a vertical start signal, a gate clock signal, a synchronous signal having a gate turn-on level and so forth. The second control signal CONT2 may include a horizontal start signal, a load signal, an inverting signal and a data clock signal.

The gate driver 300 generates respective gate signals for driving the respective gate lines GL1 to GLN in response to the first control signal CONT1 received from the timing controller 200. The gate driver 300 sequentially outputs the gate signals to the gate lines GL1 to GLN.

The gate driver circuit 300 may be directly mounted as an IC on the display panel 100, or connected to the display panel 100 in the form of a tape carrier mounted package (TCP). Alternatively, the gate driver circuit 300 may be monolithically integrated as part of the display panel 100.

The gamma voltage generator 400 generates a corresponding and analog gamma reference voltage VGREF for each of all or a preselected subset of discrete data levels represented the DATA signal supplied to the data driver 500. The gamma voltage generator 400 provides its produced analog reference voltages, VGREF to the data driver 500. As mentioned or implied above, the produced gamma reference voltages, VGREF have analog values corresponding to a gamma conversion transform of the display with the analog values each corresponding to a digitally represented discrete level of the compensated data signal DATA. In an alternate embodiment, the gamma voltage generator 500 may be integrally disposed in the timing controller 200, or in the data driver 500.

The data driver 500 receives the second control signal CONT2 and the compensated data signal DATA from the timing controller 200 and the gamma reference voltages VGREF from the gamma voltage generator 400. The data driver 500 converts digital patterns of the compensated data signal DATA into corresponding data voltages of the analog type using the gamma reference voltages VGREF for performing the digital to analog conversion (D/A), where the produced analog voltage signals are then output to respective ones of the data lines DL1 to DLM.

Internally, the data driver 500 may include a shift register (not shown), a latch (not shown), a signal processor (not shown) and a buffer (not shown). The shift register outputs a latch pulse to the latch. The latch temporarily stores the compensated data DATA, and outputs the stored compensated data signal DATA. The signal processor converts the compensated data DATA of digital type to the data voltage of an analog type based on the gamma reference voltages VGREF to thus output the corresponding data voltages. The buffer within the data driver 500 may be used to compensate the data voltages so as to have uniform levels when output to the data lines.

The data driver 500 may be directly mounted as an IC on the display panel 100, or connected to the display panel 100 as a TCP type IC. Alternatively, the data driver circuit 500 may be monolithically integrated as part of the display panel 100.

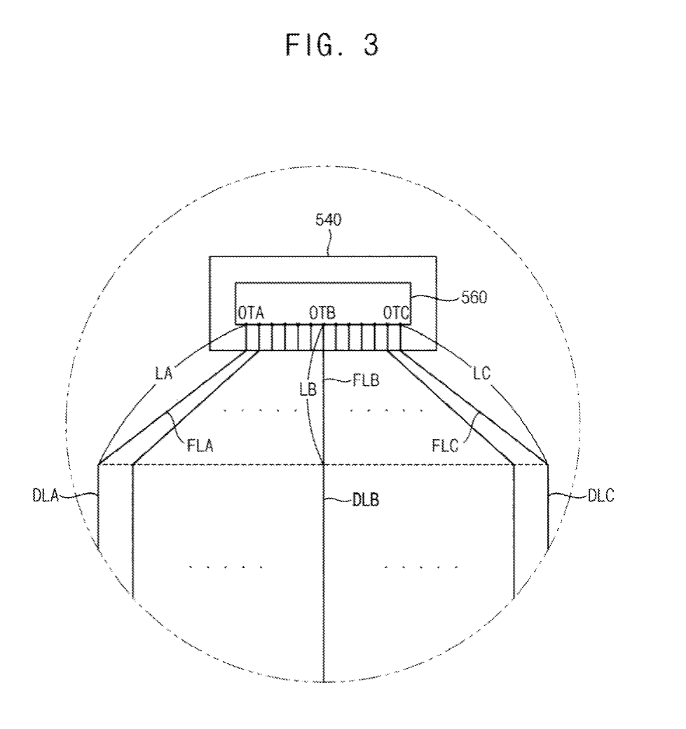

FIG. 2 is a plan view conceptually illustrating a possible physical layout for the display panel 100 and for the data driver 500 of FIG. 1. FIG. 3 is an enlarged and more detailed view of a portion A of FIG. 2.

Referring FIGS. 2 and 3, output terminals of the data driver 500 are connected to an end portion of the display panel 100. The data driver 500 includes one or more printed circuit boards 520, one or more flexible base films 540 bridging from the PCB(s) 520 to the panel 100 and one or more driving chips 560 disposed on the bridging films 540 (as shown) or alternatively disposed (not shown) on the PCB(s) 520.

Each pair of respective base film 540 and corresponding data driving chip 560 are shown to be connected in FIG. 2 to the display panel 100 with the TCP type connection scheme. It is to be understood however that the data driving chip 560 need not be limited to the TCP type. The data driving chip 560 may be directly connected to a display substrate of the display panel 100, or may be integrally mounted on the display substrate. Alternatively, the data driving chip 560 may be formed as a logic circuit, and may be monolithically integrated as part of the display panel 100 when the data line, the gate lines and the switching elements are formed.

The base film 540 serves as a supporter of the TCP type of packaging of IC 560 so that the base film 540 maintains a desired shape of the TCP. The base film 540 may have an insulating characteristic and a predetermined flexibility.

The driving chip 560 is a mixed digital/analog integrated circuit chip that outputs the analog data voltages to the display panel 100. Each driving chip 560 may be disposed at a center portion of its respective base film 540.

Each driving chip 560 includes a respective plurality of closely spaced output terminals. The output terminals are electrically connected to the fanout lines FL1 to FLM. The output terminals are connected to the fanout lines in a one to one correspondence. The fanout lines FL1 to FLM are electrically connected to adjacent ends of the parallel data lines DL1 to DLM disposed on the display panel 100. The fanout lines FL1 to FLM are connected to the data lines DL1 to DLM in a predetermined one to one correspondence such that, once it is known which output terminal of IC 560 a given drive voltage will come out of, it is also known what kind among different kinds of fanout lines the output drive voltage will travel along to get to its corresponding data line. In one embodiment, part or all of the fanout lines FL1 to FLM may be disposed on the base film 540. In one embodiment, some of the fanout lines FL1 to FLM extend along an underneath surface portion of the base film 540 while others extend along an upper surface portion of the base film 540.

In one embodiment, the fanout lines FL1 to FLM extend from the base film 540 to be further disposed in a fanout area FA of the display panel 100. The data lines DL1 to DLM are disposed in a display are DA of the display panel 100 and have ends connected to respective ones of the fanout lines.

In the embodiment of FIGS. 2 and 3, although each of portions of the fanout lines FL1 to FLM in the fanout area FA are shown as having entirely straight shapes, it is to be understood that this is merely an illustrative example and the shapes of the fanout lines FL1 to FLM is not limited to just the straight shapes. For example, each of the portions of the fanout lines FL1 to FLM in the fanout area FA may have a bent shapes and/or may include zigzag patterns.

Moreover, although FIG. 2 shows just two driving chips 560 in the data driver 500 as an example, the number of the driving chips 560 is not limited to two. For example, only one driving chip 560 may be disposed in the data driver 500. Alternatively, three or more driving chips 560 may be disposed in the data driver 500.

Referring to FIG. 3, a first output terminal OTA, which is the leftmost output terminal in the driving chip 560, is connected to a corresponding first fanout line FLA. The first fanout line FLA is connected to a corresponding first data line DLA, which is the leftmost data line in the display area DA of the display panel 100.

A second output terminal OTB, which is disposed as a center output terminal in the driving chip 560, is connected to a corresponding second fanout line FLB. The second fanout line FLB is connected to a corresponding second data line DLB disposed on the display panel 100. When one driving chip 560 is disposed in the data driver 500, the second data line DLB may be disposed in the center of the display area DA. When the number of the data lines connected to the driving chip 560 is an odd number 2P+1, the second data line DLB is the (P+1)-th data line. When the number of the data lines connected to the driving chip 560 is an even number 2Q, the second data line DLB may be one or the other of the Q-th data line and the (Q+1)-th data line.

A third output terminal OTC, which is the rightmost output terminal in the illustrated driving chip 560, is connected to a third fanout line FLC. The third fanout line FLC is connected to a corresponding third data line DLC disposed on the display panel 100. When one driving chip 560 is disposed in the data driver 500, the third data line DLC may be the rightmost data line in the display area DA.

In the linear example, the respective length, LA of the first fanout line FLA is greater than the respective length, LB of the second fanout line FLB. Assuming same consistent cross sections and materials for both wires, the resistance of each fanout line will be proportional to the length of that fanout line so that a resistance (R_{A}) of the first fanout line FL_{A} is greater than a resistance (R_{B}) of the second fanout line FL_{B}.

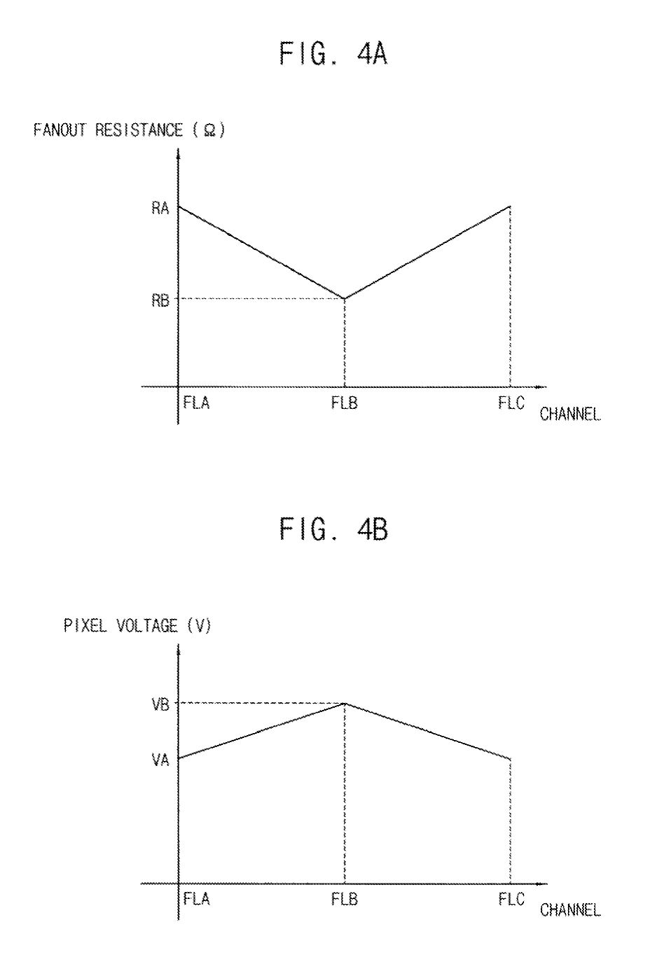

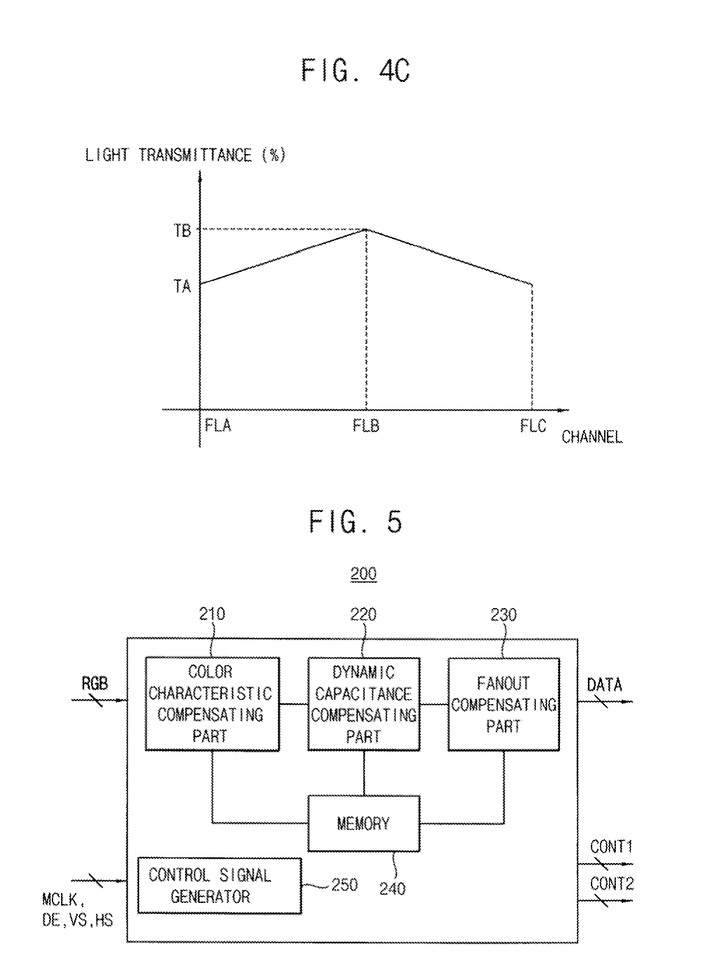

FIG. 4A is a graph illustrating a possible distribution of fanout resistances in accordance with the linearly varying a fanout lines of FIG. 2.

When discussing FIGS. 3 and 4A here, each respective path connecting a driving chip output terminal with its corresponding fanout line will be called a “channel.”

Referring to FIGS. 3 and 4A, the respective resistances of the fanout lines increase as a distance of the fanout line end from the center channel of the driving chip 560 increases. Similarly, the respective resistances of the fanout lines decrease as the distance of the fanout line end from the center channel of the driving chip 560 decreases. Thus the respective resistance, R_{A} of the first fanout line FLA is greater than the respective resistance, R_{B} of the second fanout line FLB. The resistance R_{C} of the third fanout line FLC is greater than the resistance R_{B} of the middle, second fanout line FLB. The resistance RA of the first fanout line FLA may be substantially the maximum value among the fanout line resistances. The resistance RB of the second fanout line FLB may be substantially the minimum value among the fanout line resistances.

In FIG. 4A, although a linear change of fanout resistances is illustrated as corresponding with difference between channel number and the central channel B, it is to be understood that this is just an example. The characteristic of fanout resistance versus channel number is not limited to linearly increasing and decreasing ones. Alternatively, the fanout resistance according to the channel number may be a non-linear function.

FIG. 4B is a graph illustrating voltage-divider formed, pixel voltages according to the channel number of the respective fanout line of FIG. 2.

Referring to FIGS. 3, 4A and 4B, although the data voltages outputted from the driving chip 560 to all the data lines may start out having a same uniform level, the pixel voltages transmitted to the pixels may vary according to voltage dividers that are inherently formed and include the differing resistances of the respective fanout lines. (More correctly, the charging of pixel units down a given data line may be modeled as an RC ladder network analysis with the capacitance of the pixel of the turned-on gate lines being highest. However, a linear voltage divider model suffices for explaining the basic principle of the present teachings.)

When the driving chip output data voltage is equal to Vd, the fanout resistance is equal to Rf, and the effective pixel resistance is equal to Rp, then the developed pixel voltage Vp may be determined (at least to as an acceptable first order approximation) using a first equation as following:

$$Vp = \frac{Rp}{Rp + Rf} Vd \qquad [ Equation 1 ]$$

More specifically, the pixel voltage Vp of the first pixel along the data line is obtained by dividing the chip-output data voltage, Vd using a resistive divider having the fanout resistance Rf and the effective pixel resistance Rp where the latter is deemed to be terminated to Vcom (or ground).

Therefore, as the fanout resistance Rf increases, a corresponding voltage-divider type of drop at the opposed end of the respective fanout line increases and as a result, the developed pixel voltage Vp that is transmitted to the pixel decreases. Conversely, as the fanout resistance Rf decreases, the voltage drop at the other end of the fanout line decreases so that the corresponding pixel voltage Vp transmitted to the respective pixel increases.

In FIG. 4B, the resistance of the fanout line increases as the distance of the fanout line from the center channel of the driving chip 560 increases. Accordingly, the developed pixel voltage Vp decreases with distance away from the center channel (B). Conversely, the resistance of the fanout line decreases as the distance of the closer end of the fanout line from the center channel decreases so that the correspondingly developed pixel voltage Vp at the far end of the fanout line increases, with the maximum voltage being attained when the channel number is equal to that of channel B.

In other words, a first developed pixel voltage VA of a pixel connected to the first fanout line FLA will be smaller than a second developed pixel voltage VB of a pixel connected to the second fanout line FLB even though the corresponding chip output voltages are the same. Similarly, a third developed pixel voltage VC of a pixel connected to the third fanout line FLC will be smaller than the second developed pixel voltage VB of the pixel connected to the second fanout line FLB. The first developed pixel voltage VA may be substantially the minimum value among the developed voltages of the pixels connected to the fanout lines. The second pixel voltage VB may be substantially the maximum value among the developed voltages of the pixels connected to the fanout lines.

In FIG. 4B, although the developed pixel voltage Vp is illustrated to be linearly increasing or decreasing according to difference between the channel number and the center channel B, it is to be understood that this is just an example. The characteristic of the developed pixel voltage is not limited to linear functions. Alternatively, the developed pixel voltage according to the channel number may be a non-linear function.

For example, when the data voltage Vd outputted to the first fanout line FLA is 15V, the developed first pixel voltage VA may instead be about 12.7V due to the voltage drop at the resistance RA of the first fanout line FLA. When the data voltage Vd outputted to the second fanout line FLB is 15V, the second pixel voltage VB may instead be about 14.8V due to the voltage drop at the resistance RB of the second fanout line FLB.

When the same data voltages based on the same grayscale data are outputted to the fanout lines FLA and FLB, since the resistance RA of the first fanout line FLA is greater than the resistance RB of the second fanout line FLB, the pixel voltages VA and VB developed at the corresponding pixels of the respective fanout lines FLA and FLB may be different from each other.

In order to compensate for the difference of the developed pixel voltages VA and VB, a data voltage Vd, which is greater than the data voltage outputted to the second fanout line FLB, may be outputted to the first fanout line FLA. For example, if the data voltage Vd of about 17.5 V is outputted to the first fanout line FLA, the correspondingly developed first pixel voltage VA may be about 14.8 V so that the first pixel voltage VA is substantially the same as the second pixel voltage VB.

FIG. 4C is a graph illustrating corresponding light transmittances of pixels according to the fanout line of FIG. 2 when driven by a same uniform output voltage of the driving chip.

Referring to FIGS. 3 and 4A to 4C, although the data voltages Vd outputted from the driving chip 560 to the data lines have a uniform same level, the light transmittances developed in the corresponding pixels (and thus the output luminances of those pixels) may vary according to the differing resistances of the different fanout lines.

The light transmittance is often proportional to the developed pixel voltage Vp so that the graph illustrating the light transmittance (FIG. 4C) according to the channel may have a similar shape to the graph illustrating the pixel voltage (FIG. 4B) according to the channel number.

In FIG. 4C, the pixel voltage Vp decreases as the distance of the fanout line from the center channel of the driving chip 560 increases so that the light transmittance of the pixel decreases. The pixel voltage Vp increases as the distance of the fanout line from the center channel of the driving chip 560 decreases so that the light transmittance of the pixel increases.

A light transmittance TA of the pixel connected to the first fanout line FLA is therefore smaller than a light transmittance TB of a pixel connected to the second fanout line FLB. A light transmittance TC of the pixel connected to the third fanout line FLC is therefore smaller than the light transmittance TB of the pixel connected to the second fanout line FLB. The light transmittance TA which corresponds to fanout line A may be substantially the minimum value among the comparative light transmittance percentages of pixels connected to the fanout lines. The light transmittance TB which corresponds to fanout line B may be substantially the maximum value among the comparative light transmittance percentages of pixels connected to the fanout lines.

Therefore, the light transmittance of the pixel decreases as the distance of the fanout line from the center channel of the driving chip 560 increases so that pixels of the corresponding data line may become darker than those of a data line connected to a central channel (B). The light transmittance of the pixel increases as the distance of the fanout line from the center channel of the driving chip 560 decreases so that the pixels may become brighter. For example, the pixels connected to the first fanout line FLA display an image darker than the pixels connected to the second fanout line FLB. For certain kinds of displayed images where the user expects same brightness, a banding artifact may become apparent due to the differences among the fanout lines. However, in accordance with the present disclosure, this problem is reduced or eliminated with use of electronic signal compensation.

FIG. 5 is a block diagram illustrating one embodiment of a timing controller in accordance with FIG. 1.

Referring to FIGS. 1 and 5, the exemplary timing controller 200 includes a color characteristic compensating part 210, a dynamic capacitance compensating part 220, a fanout compensating part 230, a memory 240 and a control signal generator 250. In the present example embodiment, the timing controller 200 including the color characteristic compensating part 210, the dynamic capacitance compensating part 220, the fanout compensating part 230, the memory 240 and the control signal generator 250 is illustrated in block diagram form and without the control connections being shown for convenience of explanation. However, the elements 210, 220, 230, 240 and 250 of the timing controller 200 may not be arranged as divided physical hardware blocks and their functions may instead be carried out by logically divided features of an integrated timing controller circuit 200.

The color characteristic compensating part 210 receives the input image data signal RGB (a digital signal). The color characteristic compensating part 210 then operates in accordance with a predetermined adaptive color correction algorithm (ACC) to thereby transform the input image data RGB into corresponding ACC-compensated data which is output to next block 220. In one embodiment, the color characteristic compensating part 210 compensates the input image data such as RGB data using a gamma decompression curve to thus generate linearized ACC data. The color characteristic compensating part 210 may include an ACC lookup table storing offset values sampled from a predetermined gamma curve. The ACC lookup table may be stored in the memory 240.

The dynamic capacitance compensating part 220 operates on the ACC-compensated data to thereby apply a dynamic capacitance correction factor (DCC) that corrects a grayscale data value of a present frame datum using a combination of the previous frame datum and the present frame datum. In an alternate embodiment, the dynamic capacitance compensating part 220 receives the input image data directly RGB instead of the ACC data, and operates on that to apply the dynamic capacitance correction factor (DCC) the input image data RGB. The dynamic capacitance compensating part 220 outputs DCC-compensated data. The dynamic capacitance compensating part 220 may include a first storing part storing the previous frame data and a second storing part storing the present frame data. The dynamic capacitance compensating part 220 may include a DCC lookup table (LUT) for a frame data compensation. One or more of the previous frame data, the present frame data and the DCC lookup table may be stored in the memory 240.

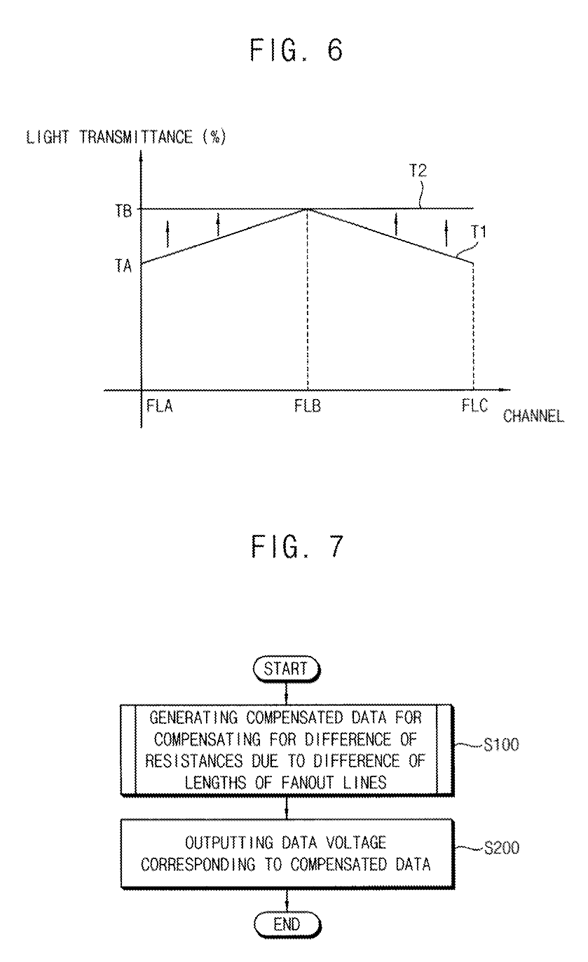

The fanout compensating part 230 receives the input image data RGB, or the ACC data or the DCC data, or data that has been operated by both of the ACC and DCC compensating blocks (210 and 220) and it (230) applies an appropriate fanout compensation algorithm to the received data so as to thereby output the fanout line compensated data, DATA. In other words, the fanout compensating part 230 compensates for the difference of resistances due to the difference of lengths of the fanout lines to thus generate the compensated data DATA. The fanout compensating part 230 may include a fanout lookup table (FLUT) storing fanout compensating values. The fanout lookup table may be stored in the memory 240. An operational outcome of the fanout compensating part 230 may be explained in more detail in conjunction with FIG. 6.

The memory 240 stores information for operation of the color characteristic compensating part 210, the dynamic capacitance compensating part 220 and the fanout compensating part 230. The memory 240 provides the information for operation of the color characteristic compensating part 210, the dynamic capacitance compensating part 220 and the fanout compensating part 230 to the color characteristic compensating part 210, the dynamic capacitance compensating part 220 and the fanout compensating part 230. Although not shown, in one embodiment the memory 240 stores a timing to channel number lookup table that indicates which channel each initial pixel signal is being directed to based on the input timing of that initial pixel signal, While in the present example embodiment the memory 240 is shown included inside the timing controller 200, the operational position of the memory 240 is not limited to being inside the timing controller 200. For example, the memory 240 may be disposed outside of the timing controller 200 and the memory 240 may have nonvolatile and dynamically changeable data storage areas.

In the system of FIG. 5, the control signal generator 250 is operatively coupled to receive the indicated external control signals and to responsively generate the first control signal CONT1 and the second control signal CONT2 where these outputs are synchronized with the timings of the output ACC/DCC/Fanout-compensated DATA signal. The timing control unit 200 of FIG. 5 outputs the first control signal CONT1 to the gate driver 300, and outputs the second control signal CONT2 to the data driver 500.

With regard to the example of FIG. 5, although the color characteristic compensating part 210, the dynamic capacitance compensating part 220 and the fanout compensating part 230 are shown by way of exemplary as sequentially disposed in the recited order (210, 220, 230), the ordering of, and sequence of operations carried out by the color characteristic compensating part 210, the dynamic capacitance compensating part 220 and the fanout compensating part 230 is not limited to that of FIG. 5 and other variations of sequence of operations, including leaving some out is contemplated here. Accordingly, the nature of the input data and the output data of any one or more of the color characteristic compensating part 210, the dynamic capacitance compensating part 220 and the fanout compensating part 230 may be also changed accordingly.

In addition, the color characteristic compensating part 210 and the dynamic capacitance compensating part 220 may be omitted.

FIG. 6 is a graph illustrating a compensation of the light transmittance of the pixels as provided with use of the compensated data signal, DATA.

Referring to FIGS. 3, 5 and 6, the fanout compensating part 230 generates the compensated data signal DATA which compensates difference of developed voltage produced at the distal ends of the fanout lines due, for example to difference of lengths of the fanout lines. In other words, initial grayscale data signals representing initial grayscale values are multiplied by corresponding fanout compensating factors to thus generate the compensated data signal DATA. In one embodiment, the fanout compensating part 230 transforms the input image data RGB using a lookup table (LUT) of fanout compensating factors, which factors may correct for example as between the greater resistance of a relatively long fanout line (e.g., FL_{A}) and the lesser resistance of a relatively shorter fanout line (e.g., FL_{B}). Thus, the data voltage Vd outputted to the channel of a relatively long fanout line is automatically made appropriately greater than the data voltage Vd outputted to the channel of a relatively short fanout line by the automated operation of the fanout compensating part 230.

FIG. 6 shows a first, uncompensated light transmittance curve T1, which represents LCD light transmittance in the case where the fanout compensation is not provided. For curve T1, the light transmittance of the respective pixel decreases as the distance of the channel feeding the fanout line, as measured from the center channel, increases to the left and right of the channel number corresponding to fanout line FL_{B}.

Since the fanout compensating part 230 generates the compensated data DATA to increase the data voltages Vd outputted to the fanout lines except for the shortest fanout line FLB with respect to the data voltage Vd outputted to the shortest fanout line FLB, the output data voltages Vd are configured to electronically counter the voltage drop effects of the longer fanout lines.

Thus, in the illustrated second light transmittance curve T2 of FIG. 6, which curve T2 represents the case where the fanout compensation is automatically applied, the light transmittance of the various pixels are a substantially uniform in response to a supplied same grayscale value regardless of the channel number. The light transmittance in the light transmittance curve T2 represents the light transmittance level TB of the pixel connected to the second fanout line FLB.

In one embodiment, the grayscale data corresponding to the grayscale is multiplied by the fanout compensating value to generate the compensated data DATA in the fanout compensating part 230. The fanout compensating value is thus inversely proportional in that embodiment to the light transmittance (T1 curve) of the pixel prior to application of the fanout compensation.

The fanout compensating factors or values may be stored in a fanout lookup table. The fanout lookup table may be stored in the memory 240. Alternatively, fanout compensating coefficients for a predetermined fanout compensating algorithm may be stored in the memory 240 and applied to the predetermined fanout compensating algorithm, where the stored fanout compensating coefficients may change according to signal channel number and the peculiarities of different ones of the fanout lines (not necessarily linear).

The fanout lookup table may store the fanout values corresponding to all channels of the driving chip 560. When the number of the output terminal of the driving chip 560 is equal to an even number 2K greater than 6, the fanout lookup table LUT1 is exampled as the following Table 1:

TABLE 1

| CHANNEL | FANOUT COMPENSATING VALUE |
|---|---|
| CH1 (FLA) | FC1 |
| CH2 | FC2 |
| CH3 | FC3 |
| . . . | . . . |
| CHK (FLB) | FCK |
| . . . | . . . |
| CH2K-2 | FC2K-2 |
| CH2K-1 | FC2K-1 |
| CH2K (FLC) | FC2K |

In the fanout lookup table LUT1, a first fanout compensating value FC1 corresponding to a first channel CH1, a second fanout compensating value FC2 corresponding to a second channel CH2 and a third fanout compensating value FC3 corresponding to a third channel CH3 are stored. The first channel CH1 may correspond to the first fanout line FLA, and the first fanout compensating value FC1 may have the substantially maximum value among the fanout compensating values.

In the fanout lookup table LUT1, a k-th fanout compensating value FCK corresponding to a k-th channel CHK is stored. The k-th channel CHK may correspond to the second (e.g., shortest) fanout line FLB, and the k-th fanout compensating value FCK may thus have the substantially minimum value among the fanout compensating values.

In the fanout lookup table LUT1, a (2K−2)-th fanout compensating value FC2K−2 corresponding to a (2K−2)-th channel CH2K−2, a (2K−1)-th fanout compensating value FC2K−1 corresponding to a (2K−1)-th channel CH2K−1 and a (2K)-th fanout compensating value FC2K corresponding to a (2K)-th channel CH2K are stored. The (2K)-th channel CH2K may correspond to the third fanout line FLC, and the (2K)-th fanout compensating value FC2K may have the substantially maximum value among the fanout compensating values.

In the present example embodiment, the data voltages Vd outputted from the respective channels to the corresponding fanout lines, except for perhaps the second fanout line FLB, are adjusted with respect to the data voltage Vd outputted to the second fanout line FLB so that the K-th fanout compensating value FCK may be substantially normalized as having the value 1. The fanout compensating values except for the K-th fanout compensating value FCK may be greater than the K-th fanout compensating value FCK so that the fanout compensating values except for the K-th fanout compensating value FCK may be greater than the normalized 1 value.

In the fanout lookup table LUT1 shown in Table 1, although the fanout values corresponding to all channels are stored, the fanout values stored in the fanout lookup table is not limited to Table 1. Alternatively, the fanout lookup table LUT2 may store the fanout values corresponding to some of the channels of the driving chip 560. When the number of the output terminal of the driving chip 560 is 2K, the fanout lookup table LUT2 is exampled as following:

TABLE 2

| CHANNEL | FANOUT COMPENSATING VALUE |
|---|---|
| CH1 (FLA) | FC1 |
| CH5 | FC5 |
| CH9 | FC9 |
| . . . | . . . |
| CHK (FLB) | FCK |
| . . . | . . . |
| CH2K-8 | FC2K-8 |
| CH2K-4 | FC2K-4 |
| CH2K (FLC) | FC2K |

In the fanout lookup table LUT2, one fanout compensating value at every 4 channels is stored. Comparing to the fanout lookup table LUT1 of Table 1, the fanout lookup table LUT2 may decrease a size of utilization of the capacity of memory part 240.

The fanout compensating part 230 may obtain the fanout compensating values for the fanout lines of the channels CH1, CH5, CH9, . . . stored in the fanout lookup table LUT2 based on the fanout lookup table LUT2, and may calculate the fanout compensating values for the fanout lines of the channels CH2, CH3, CH4, CH6, CH7, CH8, . . . , which are not stored in the fanout lookup table LUT2, using a linear interpolation.

According to the present example embodiment explained above, the fanout compensating part 230 generates the compensated data DATA for compensating for the difference of the resistances of the fanout lines so that the display quality may be improved. In addition, a complex pattern (e.g., zigzagged shapes) to compensate for the difference of the lengths of the fanout lines is not necessary so that the size of the fanout area may be decreased, and the size of the black matrix covering the fanout area may be also decreased. Accordingly, the manufacturing cost may be decreased.

Furthermore, in the present example embodiment, the compensated data DATA are generated with respect to the data voltage Vd outputted to the shortest fanout line FLB so that a luminance of the pixel may be increased.

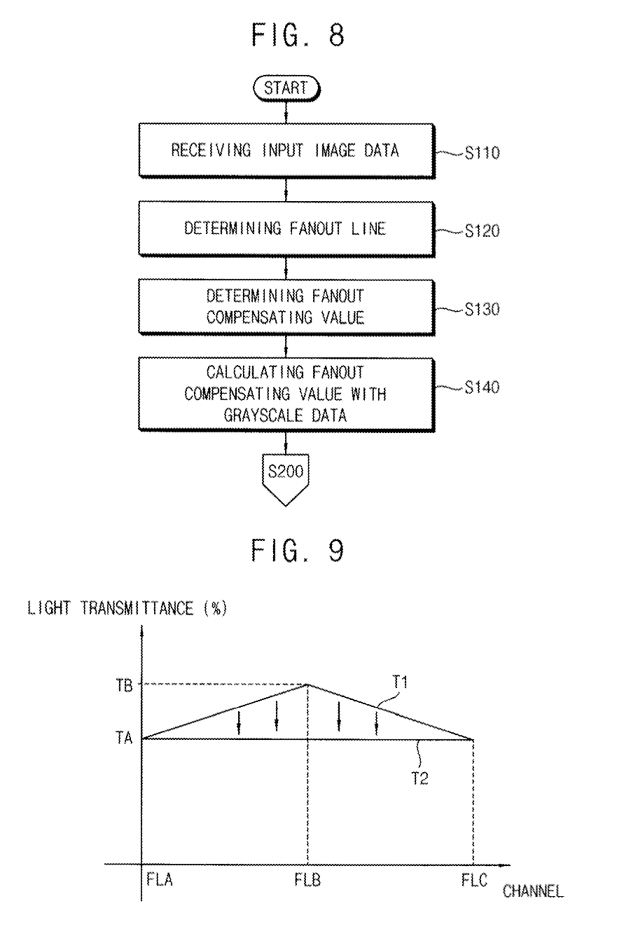

FIG. 7 is a flowchart illustrating a method of driving the display panel 100 of FIG. 1. FIG. 8 is a flowchart illustrating generating the compensated data DATA of FIG. 7.

Referring to FIGS. 3 and 5, 6, 7 and 8, the fanout compensating part 230 generates the compensated data signal DATA for compensating for the difference of the resistances due to the difference of the lengths of the fanout lines FL1 to FLM (step S100 of FIG. 7). The compensated data signal DATA may have a digital type.

The fanout compensating part 230 receives the external input image data signal RGB (step S110 of FIG. 8). Alternatively, the fanout compensating part 230 may receive the ACC data signal or the DCC data signal according to alteration of the timing controller 200.

The fanout compensating part 230 determines the nature of the corresponding fanout line (e.g., short to long) based on the timing of the corresponding initial grayscale value in the input image data signal (step S120).

The fanout compensating part 230 determines the fanout compensating value corresponding to the determined fanout line (step S130). The fanout compensating part 230 may determine the fanout compensating value using fanout lookup tables such as LUT1 or LUT2. The fanout compensating part 230 may determine the fanout compensating value using linear or nonlinear interpolation as appropriate for the nature of the fanout lines involved.

The fanout compensating part 230 automatically applies the determined fanout compensating value to the initial grayscale data value extracted from the input image data signal RGB so as to generate the compensated data DATA (step S140).

The data driver 500 respectively outputs the data voltages corresponding to the compensated data signal DATA to the data lines DL1 to DLM (step S200). The output data voltages Vd may be an analog type voltage signals.

FIG. 9 is a graph illustrating a compensation of a light transmittance of a pixel using compensated data DATA of a display apparatus according to another example embodiment. Here, rather than upwardly amplifying the output voltages to obtain level response despite different fanout lines, a voltage reduction (attenuation) approach is used to obtain the level response.

More specifically, a display apparatus according to the present second example embodiment is substantially the same as the display apparatus 1000 according to the previous example embodiment shown in FIG. 1 except for reference data of the fanout compensation of the fanout compensating part 230.

A method of driving a display panel according to the present example embodiment is substantially the same as the method of driving the display panel 100 according to the previous example embodiment shown in FIG. 7 except for reference data of the fanout compensation of the fanout compensating part 230 in the step S100. Thus, the same reference numerals will be used to refer to the same or like parts as those described in the previous example embodiment of FIGS. 1 to 8 and any repetitive explanation concerning the above elements will be omitted.

Referring to FIGS. 3, 5 and 9, the fanout compensating part 230 generates the compensated data DATA for compensating for the difference of the resistances of fanout lines due to the difference of the lengths of the fanout lines. The grayscale data representing the grayscale is attenuated by the fanout compensating value to generate the compensated data signal DATA. The fanout compensating part 230 compensates the input image data RGB using a fanout compensating value corresponding to a relatively long fanout line greater than a fanout compensating value corresponding to a relatively short fanout line. Thus, the data voltage Vd outputted to the relatively long fanout line is still greater than the data voltage Vd outputted to the relatively short fanout line.

In a light transmittance curve T1 of FIG. 9, which is measured before the fanout compensation is applied, the light transmittance of the pixel decreases as the distance of the fanout line from the center channel of the driving chip 560 increases, and the light transmittance of the pixel increases as the distance of the fanout line from the center channel of the driving chip 560 decreases.

The fanout compensating part 230 generates the compensated data signal DATA to decrease (attenuate) the data voltages Vd outputted to the fanout lines except for the longest fanout line FLA with respect to the data voltage Vd outputted to the longest fanout line FLA.

Thus, in a light transmittance curve T2 of FIG. 9, which is measured after the fanout compensation is applied, the light transmittance of the pixel has a substantially uniform value regardless of the channel number. The light transmittance in the light transmittance curve T2 represents the light transmittance TA of the pixel connected to the first fanout line FLA.

The grayscale data corresponding to the grayscale is multiplied by the fanout compensating value to generate the compensated data signal DATA in the fanout compensating part 230. The fanout compensating value is inversely proportional to the light transmittance of the pixel before the fanout compensation.

The fanout compensating values may be stored in the fanout lookup table.

In the present example embodiment, the data voltages Vd outputted to the fanout lines except for the first fanout line FLA are adjusted with respect to the data voltage Vd outputted to the first fanout line FLA so that the first fanout compensating value FC1 may be substantially normalized as 1. The fanout compensating values except for the first fanout compensating value FC1 may be smaller than the first fanout compensating value FC1 so that the fanout compensating values except for the first fanout compensating value FC1 may be smaller than 1.

According to the present example embodiment explained above, the fanout compensating part 230 generates the compensated data signal DATA for compensating for the difference of the resistances of the fanout lines so that the display quality may be improved. In addition, a complex pattern to compensate for the difference of the lengths of the fanout lines is not necessary so that the size of the fanout area may be decreased, and the size of the black matrix covering the fanout area may be also decreased. Accordingly, the manufacturing cost may be decreased.

Furthermore, in the present example embodiment, the compensated data DATA are generated with respect to the data voltage Vd outputted to the longest fanout line FLA so that the compensated data DATA values may be stably secured, and data error may be decreased.

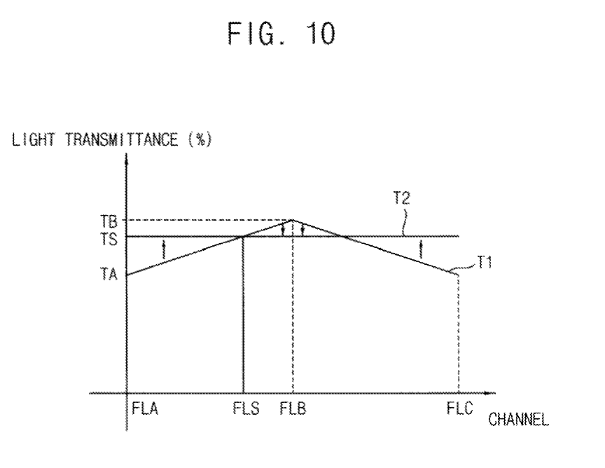

FIG. 10 is a graph illustrating a compensation of a light transmittance of a pixel using compensating data DATA of a display apparatus according to still another example embodiment in accordance with the present teachings. Here a different flat target level Ts is picked and a combination of voltage amplifications and attenuations is employed to obtain the goal flat response level curve T2.

A display apparatus according to the present example embodiment is substantially the same as the display apparatus 1000 according to the previous example embodiment shown in FIG. 1 except for reference data of the fanout compensation of the fanout compensating part 230.

A method of driving a display panel according to the present example embodiment is substantially the same as the method of driving the display panel 100 according to the previous example embodiment shown in FIG. 7 except for reference data of the fanout compensation of the fanout compensating part 230 in the step S100. Thus, the same reference numerals will be used to refer to the same or like parts as those described in the previous example embodiment of FIGS. 1 to 8 and any repetitive explanation concerning the above elements will be omitted.

Referring to FIGS. 3, 5 and 10, the fanout compensating part 230 generates the compensated data signal DATA for compensating for the difference of the resistances of fanout lines due to the difference of the lengths of the fanout lines. The grayscale data representing the grayscale is multiplied (selectively amplified or attenuated) by the fanout compensating value to generate the compensated data DATA. The fanout compensating part 230 compensates the input image data RGB using a fanout compensating value corresponding to a relatively long fanout line greater than a fanout compensating value corresponding to a relatively short fanout line. Thus, the data voltage Vd outputted to the relatively long fanout line is greater than the data voltage Vd outputted to the relatively short fanout line.

In a light transmittance curve T1, which is measured before the fanout compensation, the light transmittance of the pixel decreases as the distance of the fanout line from the center channel of the driving chip 560 increases, and the light transmittance of the pixel increases as the distance of the fanout line from the center channel of the driving chip 560 decreases.

The fanout compensating part 230 generates the compensated data DATA to increase or decrease the data voltages Vd outputted to the fanout lines except for a predetermined fanout line FLS, which is between the shortest fanout line FLB and the longest fanout line FLA, with respect to the data voltage Vd outputted to the predetermined fanout line FLS.

For example, the data voltage Vd outputted to the fanout lines longer than the predetermined fanout line FLS is greater than the data voltage Vd outputted to the predetermined fanout line FLS, and the data voltage Vd outputted to the fanout lines shorter than the predetermined fanout line FLS is smaller than the data voltage Vd outputted to the predetermined fanout line FLS.

Thus, in a light transmittance curve T2 of FIG. 10, which is measured after the fanout compensation, the light transmittance of the pixel has a substantially uniform value (TS) regardless of the channel number. The light transmittance in the light transmittance curve T2 represents the light transmittance TS of the pixel connected to the predetermined fanout line FLS.

The grayscale data corresponding to the grayscale is multiplied by the fanout compensating value to generate the compensated data signal DATA in the fanout compensating part 230. The fanout compensating value is inversely proportional to the light transmittance of the pixel before the fanout compensation.

The fanout compensating values may be stored in the fanout lookup table.

In the present example embodiment, the data voltages Vd outputted to the fanout lines except for the predetermined fanout line FLS are adjusted with respect to the data voltage Vd outputted to the predetermined fanout line FLS so that the fanout compensating value for the predetermined fanout line FLS may be substantially the normalized value of 1. The fanout compensating values for the fanout lines longer than the predetermined fanout line FLS may be greater than the fanout compensating value for the predetermined fanout line FLS so that the fanout compensating values for the fanout lines longer than the predetermined fanout line FLS may be substantially greater than 1. In addition, the fanout compensating values for the fanout lines shorter than the predetermined fanout line FLS may be smaller than the fanout compensating value for the predetermined fanout line FLS so that the fanout compensating values for the fanout lines shorter than the predetermined fanout line FLS may be substantially smaller than 1.

According to the present example embodiment explained above, the fanout compensating part 230 generates the compensated data DATA for compensating for the difference of the resistances of the fanout lines so that the display quality may be improved. In addition, a complex pattern to compensate for the difference of the lengths of the fanout lines is not necessary so that the size of the fanout area may be decreased, and the size of the black matrix covering the fanout area may be also decreased. Accordingly, the manufacturing cost may be decreased.

Furthermore, in the present example embodiment, the compensated data signal DATA are generated with respect to the data voltage Vd outputted to the predetermined fanout line FLS, which is between the shortest fanout line FLB and the longest fanout line FLA, so that the optimized compensated data DATA by compromising the luminance of the pixel and the stability of the compensated data DATA may be generated.

As explained above, according to the present disclosure of invention, the difference of the resistances and/or other voltage affecting attributes of the different fanout lines may be compensated for without enlarging the fanout area through the use of zigzagging or the like. Thus, the display quality may be improved, and the cost and complexity for manufacturing the display panel may be decreased.

The foregoing is illustrative of the present teachings and is not to be construed as limiting thereof. Although a few example embodiments in accordance with the present disclosure have been described, those skilled in the art will readily appreciate from the foregoing that many modifications are possible in the example embodiments without materially departing from the novel teachings and advantages of the present disclosure. Accordingly, all such modifications are intended to be included within the scope of the present teachings. In the claims, means-plus-function clauses are intended to cover the structures described herein as performing the recited function and not only the structural equivalents but also functionally equivalent structures. Therefore, it is to be understood that the foregoing is illustrative and is not to be construed as limited to the specific example embodiments disclosed, and that modifications to the disclosed example embodiments, as well as other example embodiments, are intended to be included within the scope of the present teachings.

What is claimed is:

1. A method of driving a display panel that has differing fanout lines coupling respective drive voltage outputting channels disposed at near and close together ends of the fanout lines to corresponding ends of respective data lines where the data line ends are disposed at distal and further spaced apart ends of the fanout lines, the method comprising:
receiving an initial image-representing digital data signal and automatically generating therefrom a corresponding, compensated digital data signal that counter-compensate for a difference of developed voltage that would otherwise appear at the distal end of a corresponding fanout line in response to a predetermined drive voltage presented at the voltage outputting channel of that corresponding fanout line, where the difference of developed voltage is due to a difference of resistance in the corresponding fanout line relative to a different resistance of at least one differing other one of the fanout lines; and
respectively outputting an analog data voltage corresponding to the compensated digital data signal from a respective one of the drive voltage outputting channels for thereby transmitting the output analog data voltage through the corresponding fanout line to thus drive a corresponding one of the data lines.

2. The method of claim 1 wherein:
the generating of the corresponding, compensated digital data signal includes receiving an initial grayscale digital data signal representing a corresponding grayscale and digitally multiplying the received initial grayscale digital data signal by a selected fanout compensating value to thus generate the corresponding, compensated digital data signal, and
where the selected fanout compensating value is selected from a plurality of stored fanout compensating values respectively corresponding to fanout lines of the display that have relatively large resistances and to fanout lines of the display that have relatively smaller resistances.

3. The method of claim 2, wherein the fanout compensating value is inversely proportional to a light transmittance reduction value of a pixel connected to the data line of the corresponding output channel, where the light transmittance reduction value is a percentage of light transmittance ability lost due to the difference of developed voltage.

4. The method of claim 2, wherein the generating of the corresponding, compensated digital data signal comprises:
receiving an external R, G or B input image data signal;
automatically determining a fanout line corresponding to the received R, G or B input image data signal;
automatically determining the fanout compensating value corresponding to the determined fanout line; and
automatically applying the determined fanout compensating value to a grayscale value of the received R, G or B input image data signal to thereby produce a corresponding compensated R, G or B image data signal.

5. The method of claim 4, wherein the fanout compensating value is determined using a lookup table storing the plurality of fanout compensating values.

6. The method of claim 5, wherein the lookup table stores one base fanout compensating value for a plurality of the fanout lines,
the base fanout compensating value for a given fanout line is determined based on the lookup table, and
linear interpolation is used to produce from the base fanout compensating value, a refined fanout compensating value of a fanout line whose refined fanout compensating value is not stored in the lookup table.

7. The method of claim 2, wherein the compensated data increases the data voltages outputted to the fanout lines except for the shortest fanout line with respect to the data voltage outputted to the shortest fanout line.

8. The method of claim 2, wherein the compensated data decreases the data voltages outputted to the fanout lines except for the longest fanout line with respect to the data voltage outputted to the longest fanout line.

9. The method of claim 2, wherein the compensated data decreases the data voltages outputted to the fanout lines shorter than a first predetermined length with respect to the data voltage outputted to a fanout line having the first length, and
the compensated data increases the data voltages outputted to the fanout lines longer than the first predetermined length with respect to the data voltage outputted to the fanout line having the first length.

10. A display apparatus comprising:
a display panel comprising a plurality of data lines spaced apart at a first pitch dimension;
a driving chip having a plurality of output terminals for outputting a corresponding plurality of data voltages to the data lines, where the chip output terminals are spaced apart by a dimension smaller than the first pitch dimension of the data lines;
a fanout part having a plurality of fanout lines of differing resistances, the fanout lines providing interconnection between corresponding ones of the chip output terminals and the data lines; and
a timing controller structured to generate compensated digital data signals that electronically compensate for differences of resistances amongst the differing fanout lines so that analog voltages delivered to respective ones of the data lines are not varied as a result of the differing resistances of the fanout lines.

11. The display apparatus of claim 10, wherein the timing controller includes a grayscale data adjusting part that automatically applies selected fanout compensating values to corresponding grayscale representing data signals to thereby generate the compensated digital data signals.

12. The display apparatus of claim 11, wherein the fanout compensating value is inversely proportional to a light transmittance of a pixel connected to the data line.

13. The display apparatus of claim 11, wherein the selected fanout compensating values are stored in a lookup table of the display apparatus.

14. The display apparatus of claim 13, wherein the lookup table stores the fanout compensating values corresponding to a part of the fanout lines, and
the timing controller automatically determines the fanout compensating value for the fanout line stored in the lookup table based on the lookup table and the fanout compensating value for the fanout line, which is not stored in the lookup table, using a linear interpolation.

15. The display apparatus of claim 13, further comprising a memory storing the lookup table.

16. The display apparatus of claim 11, wherein the timing controller generates the compensated data in a way that increases the data voltages outputted to the fanout lines except for the shortest fanout line with respect to the data voltage outputted to the shortest fanout line.

17. The display apparatus of claim 11, wherein the timing controller generates the compensated data in a way that decreases the data voltages outputted to the fanout lines except for the longest fanout line with respect to the data voltage outputted to the longest fanout line.

18. The display apparatus of claim 11, wherein the timing controller generates the compensated data to decrease the data voltages outputted to the fanout lines shorter than a first length with respect to the data voltage outputted to a fanout line having the first length, and to increase the data voltages outputted to the fanout lines longer than the first length with respect to the data voltage outputted to the fanout line having the first length.
